(19) United States
(12) Patent Application Publication
(10) Pub. No.: US 2019/0114002 A1
(43) Pub. Date: Apr. 18, 2019

(54) TOUCH PANEL-EQUIPPED DISPLAY DEVICE

(71) Applicant: SHARP KABUSHIKI KAISHA, Sakai City, Osaka (JP)

(72) Inventors: JEAN MUGIRANEZA, Sakai City (JP); TOMOHIRO KIMURA, Sakai City (JP); YASUHIRO SUGITA, Sakai City (JP); HISASHI WATANABE, Sakai City (JP); MASAFUMI UENO, Sakai City (JP)

(21) Appl. No.: 16/090,254

(22) PCT Filed: Mar. 24, 2017
(86) PCT No.: PCT/JP2017/012130

§ 371 Date: Sep. 30, 2018

(30) Foreign Application Priority Data
Mar. 30, 2016 (JP) 2016-068575

(51) Int. Cl. G06F 3/044; G06F 3/041; G06F 1/16; G02F 1/1333; G02F 1/1343; G09G 3/36

(52) U.S. Cl. CPC G06F 3/044; G06F 3/0412; G06F 1/1607; G09G 3/3648; G02F 1/13338; G02F 1/134363; G06F 1/1626

(57) ABSTRACT

A touch on a housing that accommodates a liquid crystal panel is excellently detected. A capacitive touch panel for operating the liquid crystal panel includes a transmitting electrode (T) driven by a drive voltage, a receiving electrode (R) to read a signal based on a capacitance in between the receiving electrode (R) and the transmitting electrode (T), and a housing transmitting electrode (HT) disposed on the housing.

### TECHNICAL FIELD

The present invention relates to a touch panel-equipped display device in which a display panel has a capacitive touch panel disposed thereon for operating the display panel.

### BACKGROUND ART

A touch panel-equipped display device in which a display panel has a capacitive touch panel disposed thereon enabling a user to touch with a finger or the like to input information is known (PTL 1).

FIG. 22 is a perspective diagram of a conventional touch panel-equipped display device 91. FIG. 23 is a schematic cross-section diagram of the conventional touch panel-equipped display device 91.

The touch panel-equipped display device 91 includes a housing 93 formed in a rectangular parallelepiped shape that accommodates a display panel (not illustrated) and a capacitive touch panel 94 disposed on the display panel so as to operate the display panel. The capacitive touch panel 94 includes a plurality of transmitting electrodes T disposed in parallel with each other and driven by a drive voltage and a plurality of receiving electrodes R disposed in parallel with each other so as to cross the plurality of transmitting electrodes T and arranged to read a signal based on a capacitance in between the receiving electrodes R and the transmitting electrodes T driven by the drive voltage, on the display panel.

### CITATION LIST

### Patent Literature

PTL 1: U.S. Pat. No. 8,786,557

### SUMMARY OF INVENTION

### Technical Problem

However, with a conventional technique as described above, the transmitting electrodes T and the receiving electrodes R are disposed on the display panel. With this, even when touching an edge of the housing 93, a detection signal is small. This poses a problem in that a detectable position of a touch is limited to a position on the display panel and it is difficult to detect a touch on an edge of the housing 93.

In view of the above-described problem, it is one objective of the invention to implement a touch panel-equipped display device enabling excellent detection of a touch on a housing that accommodates a display panel.

### Solution to Problem

To solve the above-described problem, a touch panel-equipped display device according to an aspect of the present invention is a touch panel-equipped display device that includes a display panel, a housing that accommodates the display panel, and a capacitive touch panel for operating the display panel. The capacitive touch panel has a transmitting electrode driven by a drive voltage and a receiving electrode arranged to read a signal based on a capacitance in between the receiving electrode and the transmitting electrode driven by the drive voltage, and at least one of the transmitting electrode and the receiving electrode is disposed on the housing.

### Advantageous Effects of Invention

According to an aspect of the present invention, a touch panel-equipped display device enabling excellent detection of a touch on a housing that accommodates a display panel can be provided.

### BRIEF DESCRIPTION OF DRAWINGS

FIG. 1 is a perspective diagram of touch panel-equipped display device according to a first embodiment.

FIG. 2 is a cross-section diagram illustrating a configuration of a liquid crystal panel, a capacitive touch panel, and a housing that are provided on the above-described touch panel-equipped display device.

FIG. 3 is a block diagram of the above-described touch panel-equipped display device.

FIG. 4 is a schematic plan diagram of the above-described touch panel-equipped display device.

FIG. 5 is an exploded diagram for explaining a configuration of the capacitive touch panel and the housing of the above-described touch panel-equipped display device.

FIG. 6 is a schematic cross-section diagram of the above-described touch panel-equipped display device.

FIG. 7 is a schematic cross-section diagram illustrating a connection configuration of a transmitting electrode and a receiving electrode that are provided on the above-described capacitive touch panel with the housing.

FIG. 8(a) is a graph illustrating touch signal distribution detected when touching the housing of the above-described touch panel-equipped display device. FIG. 8(b) is a graph illustrating touch signal distribution detected when touching a housing of a conventional touch panel-equipped display device.

FIG. 9(a) is a perspective diagram of a touch panel-equipped display device according to a second embodiment. FIG. 9(b) is a perspective diagram of another touch panel-equipped display device according to the second embodiment.

FIG. 10 is a perspective diagram of still another touch panel-equipped display device according to the second embodiment.

FIG. 11 is a plan diagram of a touch panel-equipped display device according to a third embodiment.

FIGS. 12(a) and 12(b) each are a schematic cross-section diagram illustrating a connection configuration of a wire provided on a touch panel of a touch panel-equipped display device according to a fourth embodiment and a housing transmitting electrode formed on a housing.

FIG. 13(a) is a schematic plan diagram of a touch panel-equipped display device according to a fifth embodiment. FIG. 13(b) is a schematic cross-section diagram thereof.

FIG. 14(a) is a schematic plan diagram of a conventional touch panel-equipped display device. FIG. 14(b) is a schematic cross-section diagram thereof.

FIG. 15(a) is a schematic plan diagram of another touch panel-equipped display device according to the fifth embodiment. FIG. 15(b) is a schematic cross-section diagram thereof.

FIG. 16(a) is a schematic plan diagram of still another touch panel-equipped display device according to the fifth embodiment. FIG. 16(b) is a schematic cross-section diagram thereof.

FIG. 17(a) is a schematic plan diagram of a conventional touch panel-equipped display device. FIG. 17(b) is a schematic cross-section diagram thereof.

FIG. 18(a) is a perspective diagram of a touch panel-equipped display device according to a sixth embodiment. FIG. 18(b) is a circuit diagram of a proximity sensor provided on the above-described touch panel-equipped display device.

FIG. 19(a) is a perspective diagram of another touch panel-equipped display device according to the sixth embodiment. FIG. 19(b) is a schematic cross-section diagram of the above-described touch panel-equipped display device. FIG. 19(c) is a circuit diagram of an environment sensor provided on the above-described touch panel-equipped display device.

FIG. 20(a) is a perspective diagram of still another touch panel-equipped display device according to the sixth embodiment. FIG. 20(b) is a schematic cross-section diagram of the above-described touch panel-equipped display device.

FIG. 21(a) is a perspective diagram of yet another touch panel-equipped display device according to the sixth embodiment. FIG. 21(b) is a schematic cross-section diagram of the above-described touch panel-equipped display device. FIG. 21(c) is a block diagram illustrating a relation among a loop antenna, a near-field communication radar, and a sensing circuit that are provided on the above-described touch panel-equipped display device.

FIG. 22 is a perspective diagram of a conventional touch panel-equipped display device.

FIG. 23 is a schematic cross-section diagram of the conventional touch panel-equipped display device.

### DESCRIPTION OF EMBODIMENTS

Hereinafter, embodiments of the present invention will be described in details.

### First Embodiment

### (Configuration of Touch Panel-Equipped Display Device 1)

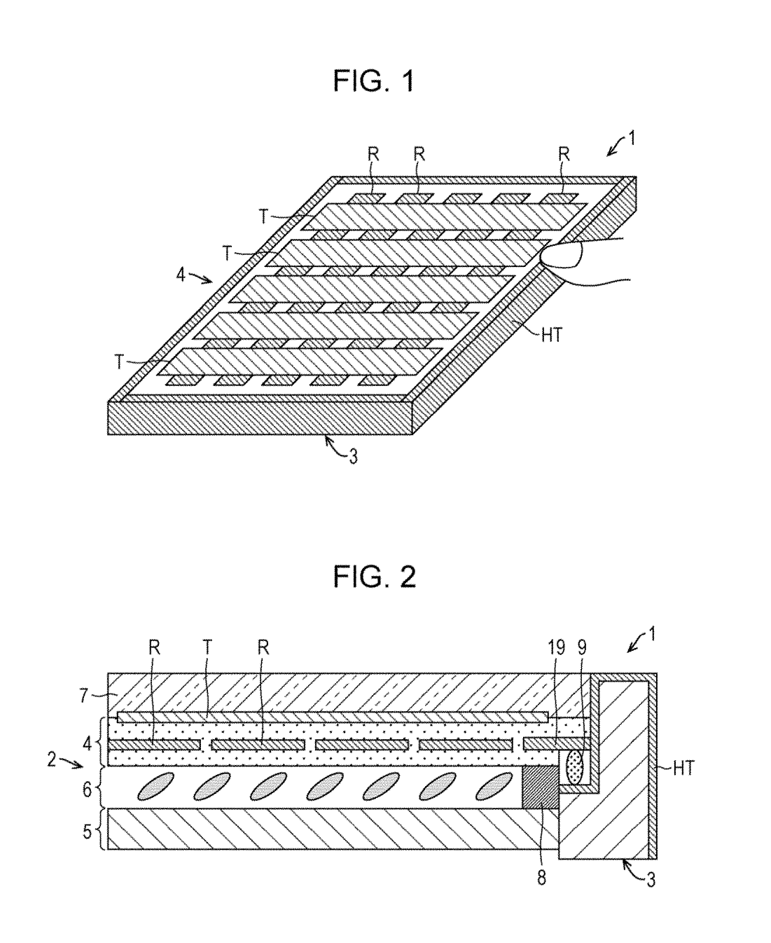

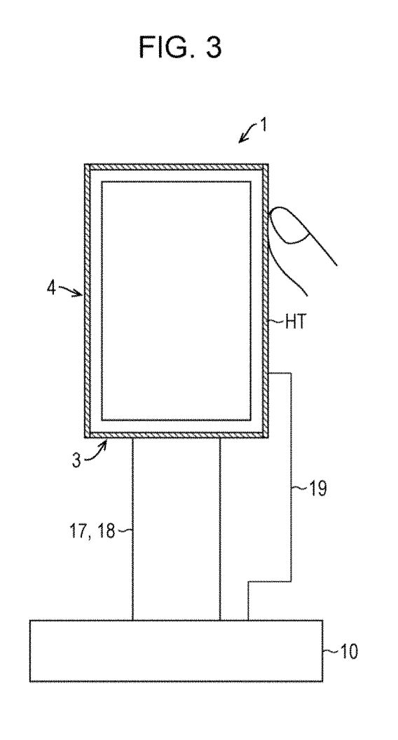

FIG. 1 is a perspective diagram of touch panel-equipped display device 1 according to a first embodiment. FIG. 2 is a cross-section diagram illustrating a configuration of a liquid crystal panel 2 (display panel), a capacitive touch panel 4, and a housing 3 that are provided on the touch panel-equipped display device 1. FIG. 3 is a block diagram of the touch panel-equipped display device 1.

The touch panel-equipped display device 1 includes the liquid crystal panel 2, the housing 3 formed in a rectangular parallelepiped shape that accommodates the liquid crystal panel 2, the capacitive touch panel 4 for operating the liquid crystal panel 2, and a touch panel controller 10 that controls the capacitive touch panel 4. The liquid crystal panel 2 has a thin film transistor (TFT) substrate 5, a cover glass 7, and a liquid crystal layer 6 formed between the TFT substrate 5 and the cover glass 7. Between the liquid crystal layer 6 and the cover glass 7, the capacitive touch panel 4 is disposed. Between the capacitive touch panel 4 and the TFT substrate 5, a seal member 8 is provided.

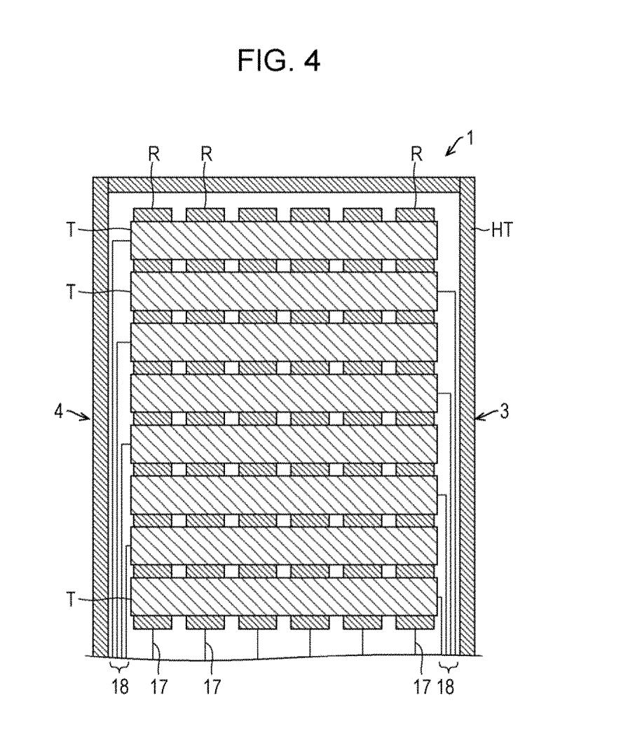

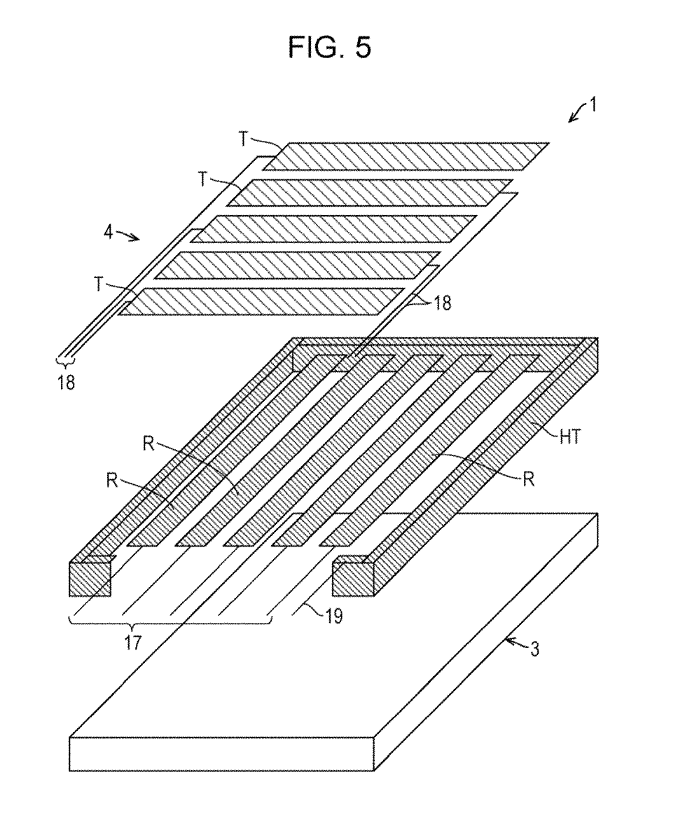

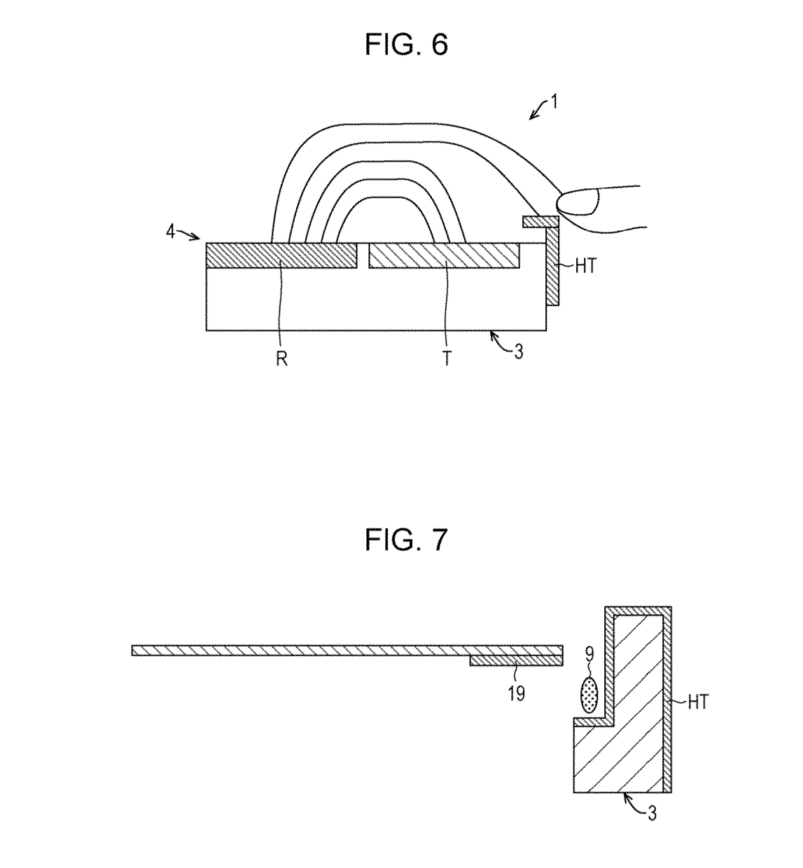

FIG. 4 is a schematic plan diagram of the touch panel-equipped display device 1. FIG. 5 is an exploded diagram for explaining a configuration of the capacitive touch panel 4 and the housing 3 of the touch panel-equipped display device 1. FIG. 6 is a schematic cross-section diagram of the touch panel-equipped display device 1. FIG. 7 is a schematic cross-section diagram illustrating a connection configuration of a transmitting electrode T and a receiving electrode R that are provided on the capacitive touch panel 4 with the housing 3.

The capacitive touch panel 4 includes a plurality of band-shaped transmitting electrodes T disposed in parallel with each other and driven by a drive voltage and a plurality of band-shaped receiving electrodes R disposed in parallel with each other so as to cross the plurality of transmitting electrodes T and arranged to read a signal based on a capacitance in between the receiving electrodes R and the transmitting electrodes T driven by the drive voltage, on the liquid crystal panel 2. The transmitting electrode T is connected to the touch panel controller 10 via a wire 17 and the receiving electrode R is connected to the touch panel controller 10 via a wire 18.

The capacitive touch panel 4 further includes a housing transmitting electrode HT that is formed continuously along four side walls of the housing 3 and driven by the drive voltage. The housing transmitting electrode HT is formed so as to extend from the outer faces to the inner faces of the side walls of the housing 3 by passing through the surface of the housing 3 and connected to the touch panel controller 10 via a conductive seal member 9 and a wire 19 that are provided on the inner faces of the side walls of the housing 3.

The housing transmitting electrode HT is formed continuously along the side walls of the housing 3, enabling easy electrode formation. For example, when the housing 3 is made of metal, no electrode has to be additionally formed for the housing transmitting electrode HT.

### (Operation of Touch Panel-Equipped Display Device 1)

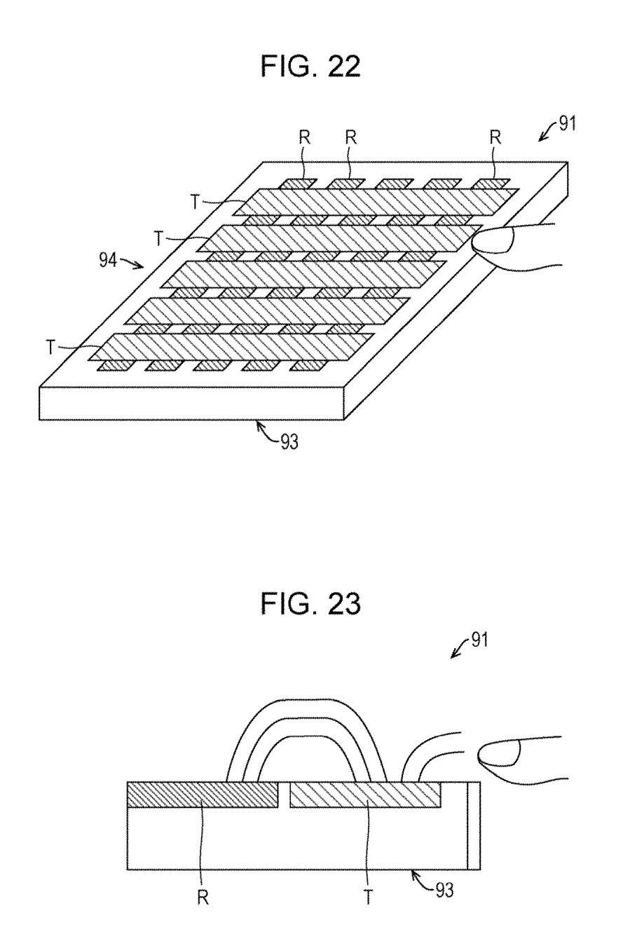

When the housing 3 of the touch panel-equipped display device 1 according to the first embodiment is touched by a finger, because the housing transmitting electrode HT is formed on the housing 3, a capacitance between this housing transmitting electrode HT and the receiving electrode R disposed on the surface of the liquid crystal panel 2 accommodated in the housing 3 changes more greatly. This is because, when the housing transmitting electrode HT is formed on the housing 3, the finger is closer to a transmitting electrode, compared with a case where the finger touches a housing 93 of a conventional touch panel-equipped display device 91 (FIG. 22), in which transmitting electrodes and receiving electrodes are not formed on the housing 3, but formed only on the liquid crystal panel 2.

With this, the touch panel controller 10 reads out a signal based on a change in a capacitance between the housing transmitting electrode HT and the receiving electrode R through the receiving electrode R and the wire 17, enabling excellent detection of a touch by the finger on the housing 3.

When excellent detection of a touch on the housing 3 is enabled as described above, the surface of the liquid crystal panel 2 does not have to be touched by a finger, and only touching the housing 3 can operate the touch panel-equipped display device 1. With this, a mobile device mounted with the touch panel-equipped display device 1 can be operated with one hand, improving easiness in operation.

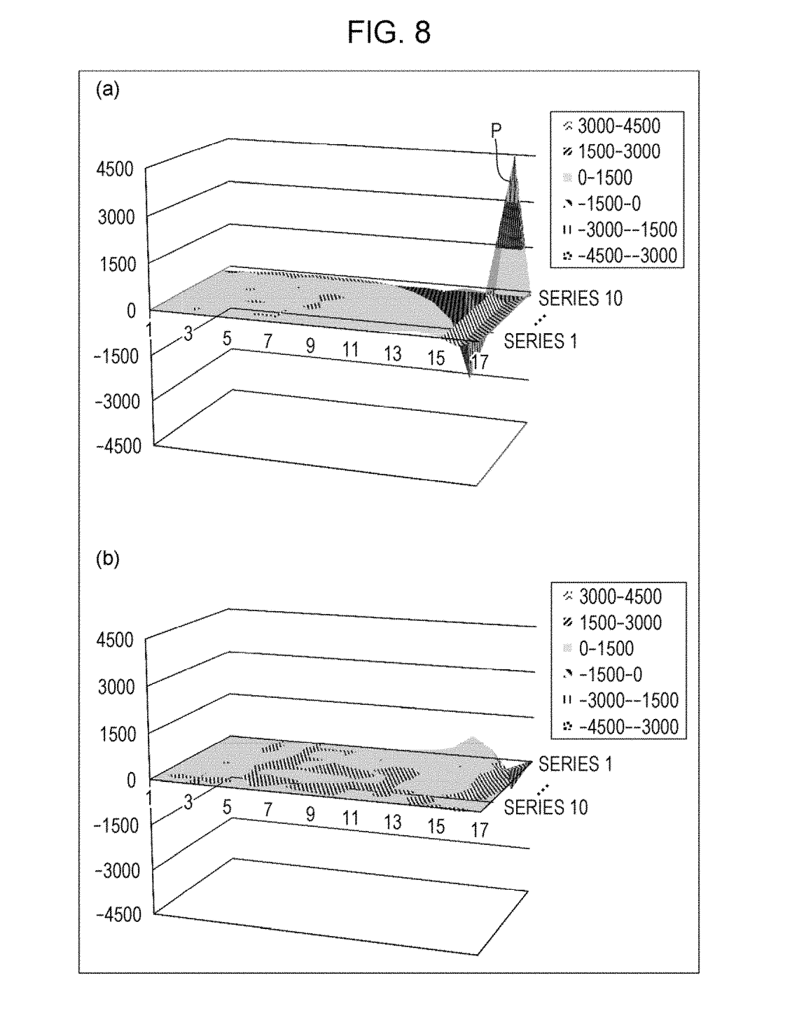

FIG. 8(a) is a graph illustrating touch signal distribution detected when touching the housing 3 of the touch panel-equipped display device 1. FIG. 8(b) is a graph illustrating touch signal distribution detected when touching the housing 93 of the conventional touch panel-equipped display device 91. When the housing transmitting electrode HT is formed on the housing 3, as illustrated in FIG. 8(a), a signal P with a high peak value is detected. However, with the conventional touch panel-equipped display device 91 (FIGS. 22 and 23) in which the housing transmitting electrode HT is not formed on the housing 3, the finger touching the housing 3 is distant from the transmitting electrodes T and the receiving electrodes R on the liquid crystal panel 2, and thus no signal with a high peak value is detected, as illustrated in FIG. 8(b).

### Second Embodiment

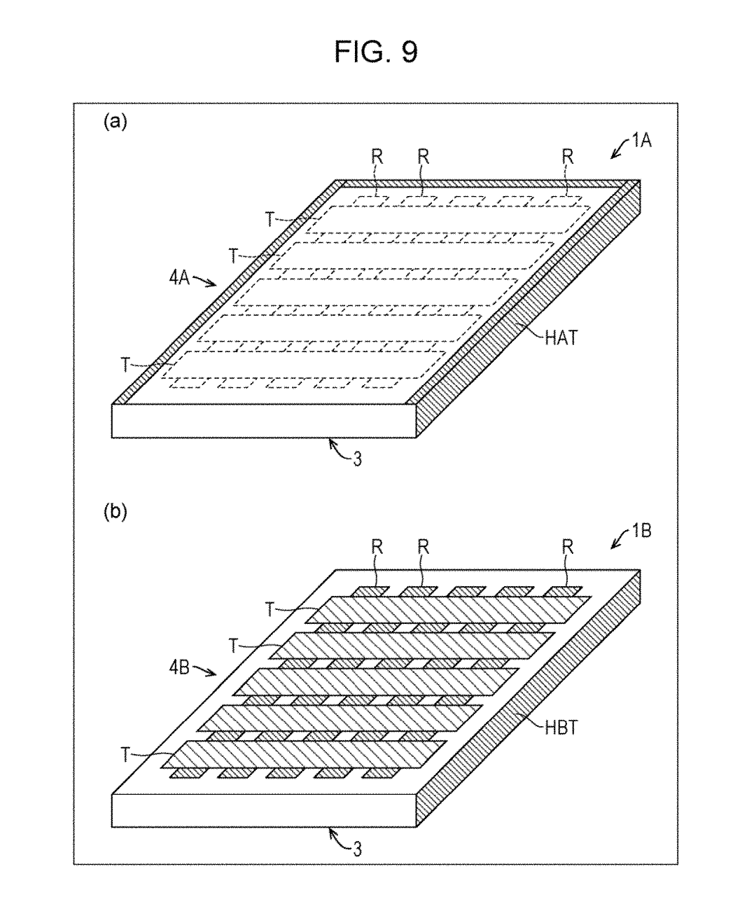

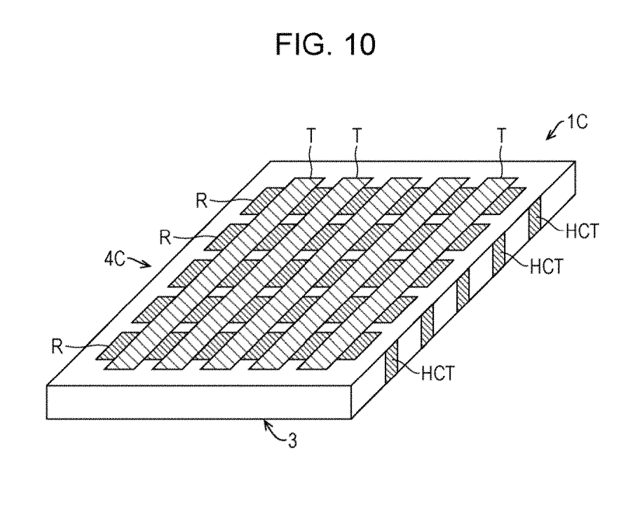

Another embodiment of the present invention will be described below with reference to FIGS. 9 and 10. It is to be noted that for the convenience of explanation, a component having the same function as that described in the above-described embodiment will be denoted with the same reference character, and the description thereof will be omitted.

FIG. 9(a) is a perspective diagram of a touch panel-equipped display device 1A according to a second embodiment. FIG. 9(b) is a perspective diagram of another touch panel-equipped display device 1B according to the second embodiment.

A capacitive touch panel 4A of the touch panel-equipped display device 1A includes a housing transmitting electrode HAT formed in a U shape continuously along three side walls of the housing 3 and driven by a drive voltage, as illustrated in FIG. 9(a).

A capacitive touch panel 4B of the touch panel-equipped display device 1B includes a housing transmitting electrode HBT formed in an I shape continuously along one side wall of the housing 3 and driven by a drive voltage, as illustrated in FIG. 9(b).

The housing transmitting electrodes HAT and HBT are formed continuously along the side walls of the housing 3, enabling easy electrode formation. For example, when the housing 3 is made of metal, no electrode has to be additionally formed for the housing transmitting electrodes HAT and HBT.

FIG. 10 is a perspective diagram of still another touch panel-equipped display device 1C according to the second embodiment. A capacitive touch panel 4C of the touch panel-equipped display device 1C includes a plurality of housing transmitting electrodes HCT formed dividedly along a side wall of the housing 3, as illustrated in FIG. 10. The plurality of housing transmitting electrodes HCT are formed on the outer face of the side wall of the housing 3.

With this configuration, a plurality of housing transmitting electrodes HCT are formed on a side wall of the housing 3, and thus, the resolution at the time of detection of a touch on the side wall of the housing 3 is improved.

### Third Embodiment

The transmitting electrodes T and the receiving electrodes R that have been presented in the above-described embodiments have band-shaped patterns. However, the present invention is not limited thereto.

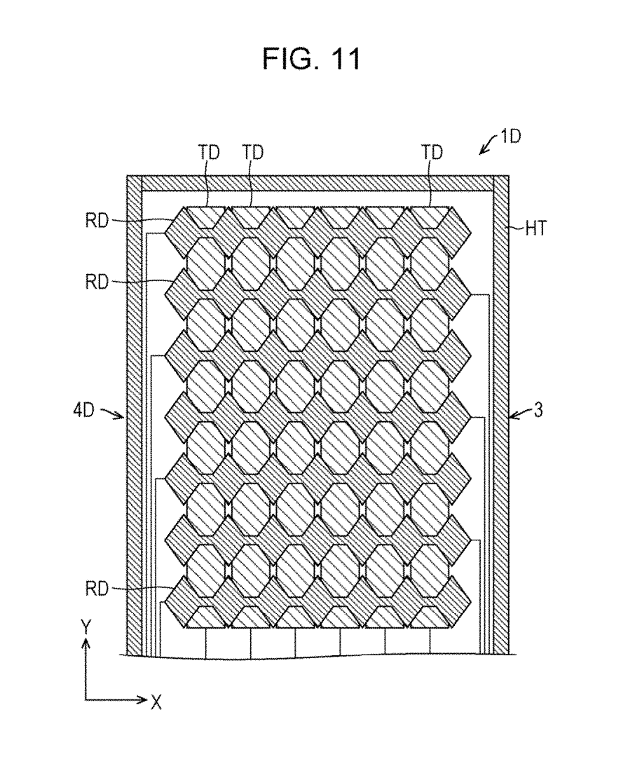

FIG. 11 is a plan diagram of a touch panel-equipped display device 1D according to a third embodiment. A component having the same function as that described in the above-described embodiments will be denoted with the same reference character, and the description thereof will be omitted.

A capacitive touch panel 4D of the touch panel-equipped display device 1D includes a plurality of transmitting electrodes TD disposed in parallel with each other and driven by a drive voltage and a plurality of receiving electrodes RD disposed in parallel with each other so as to cross the plurality of transmitting electrodes TD and arranged to read a signal based on a capacitance in between the receiving electrodes RD and the transmitting electrodes TD driven by the drive voltage.

Each of the transmitting electrodes TD has a shape formed with a substantially diamond shape iteratively arranged in the X-axis direction. Each of the receiving electrodes RD has a shape formed with a substantially octagon shape iteratively arranged in the Y-axis direction.

### Fourth Embodiment

The housing transmitting electrode HT of the housing 3 that has been presented in the above-described embodiment is connected to the wire 19 coupled to the touch panel controller 10 via the conductive seal member 9. However, the present invention is not limited thereto.

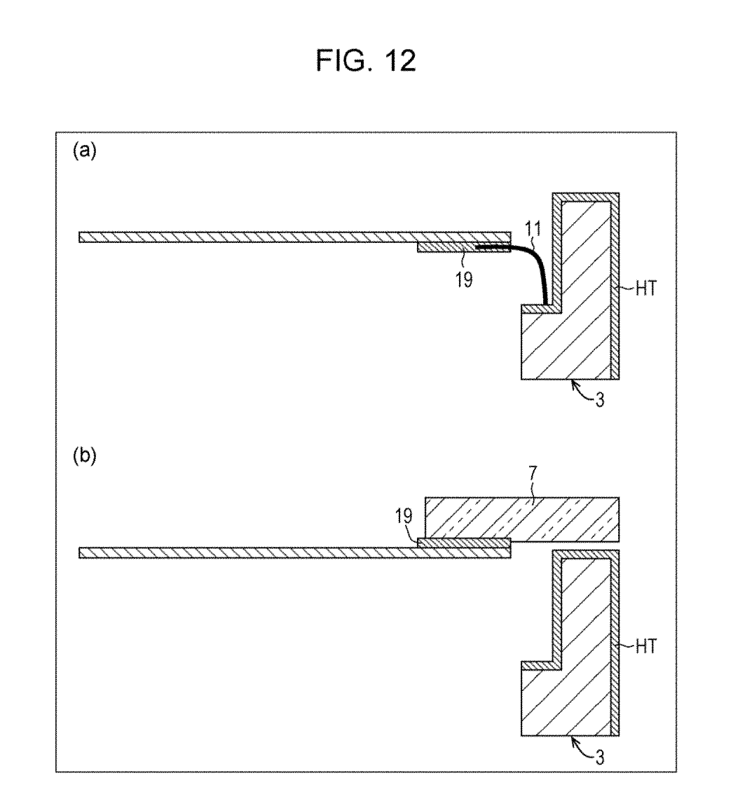

FIGS. 12(a) and 12(b) each are a schematic cross-section diagram illustrating a connection configuration of the wire 19 provided on a touch panel of a touch panel-equipped display device according to a fourth embodiment and the housing transmitting electrode HT formed on the housing 3. A component having the same function as that described in the above-described embodiments will be denoted with the same reference character, and the description thereof will be omitted.

The housing transmitting electrode HT may be connected to the wire 19 via a flexible connector 11, as illustrated in FIG. 12(a).

Furthermore, the housing transmitting electrode HT may be connected to the wire 19 via the cover glass 7, as illustrated in FIG. 12(b).

### Fifth Embodiment

The housing 3 presented in the above-described embodiments is formed in a rectangular parallelepiped shape. However, the present invention is not limited thereto.

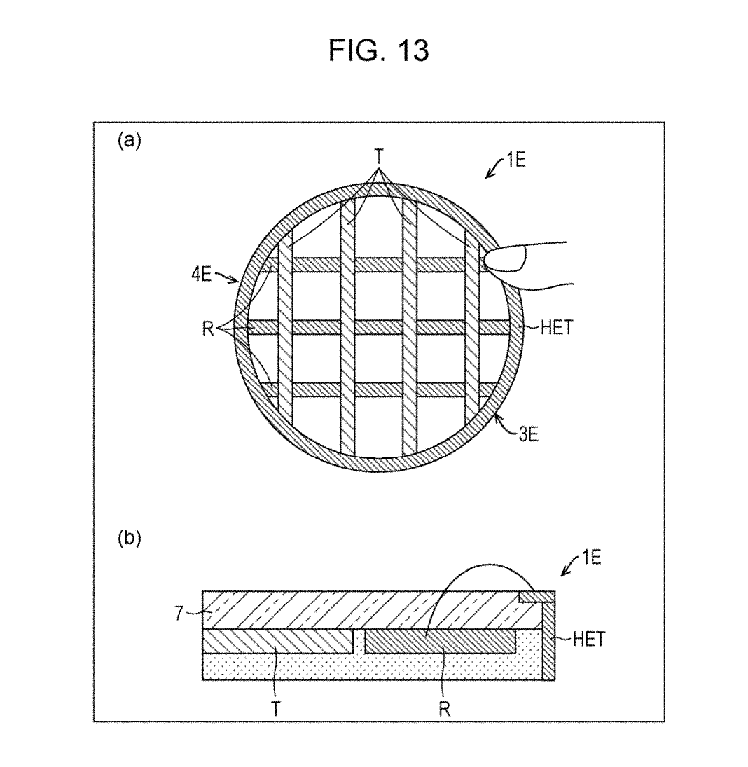

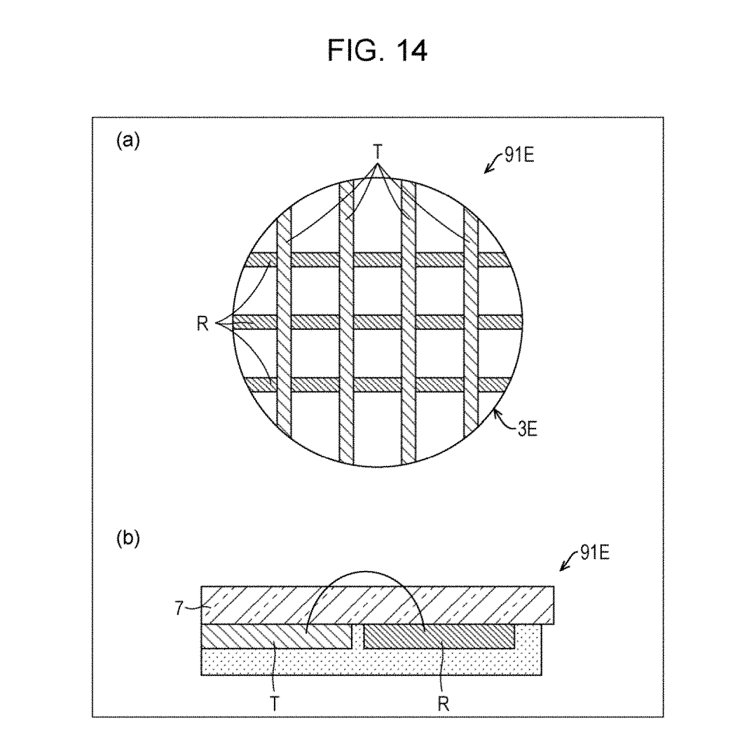

FIG. 13(a) is a schematic plan diagram of a touch panel-equipped display device 1E according to a fifth embodiment. FIG. 13(b) is a schematic cross-section diagram thereof. FIG. 14(a) is a schematic plan diagram of a conventional touch panel-equipped display device 91E. FIG. 14(b) is a schematic cross-section diagram thereof. A component having the same function as that described in the above-described embodiments will be denoted with the same reference character, and the description thereof will be omitted.

The conventional touch panel-equipped display device 91E formed in a disc shape has no electrode on a housing 3E, as illustrated in FIGS. 14(a) and 14(b). When the housing 3E is touched, the detection signal is low, making it difficult to detect the touch.

The housing 3E of the touch panel-equipped display device 1E has a disc shape, as illustrated in FIG. 13(a), and accommodates a disc-shaped display panel (not illustrated). On the disc-shaped display panel, a circular capacitive touch panel 4E is disposed. The capacitive touch panel 4E is provided with a housing transmitting electrode HET formed on the outer edge and the circumferential face of the surface of the housing 3E.

The capacitive touch panel 4E includes a plurality of band-shaped transmitting electrodes T disposed in parallel with each other and driven by a drive voltage and a plurality of band-shaped receiving electrodes R disposed in parallel with each other so as to cross the plurality of transmitting electrodes T and arranged to read a signal based on a capacitance in between the receiving electrodes R and the transmitting electrodes T driven by the drive voltage, on the display panel.

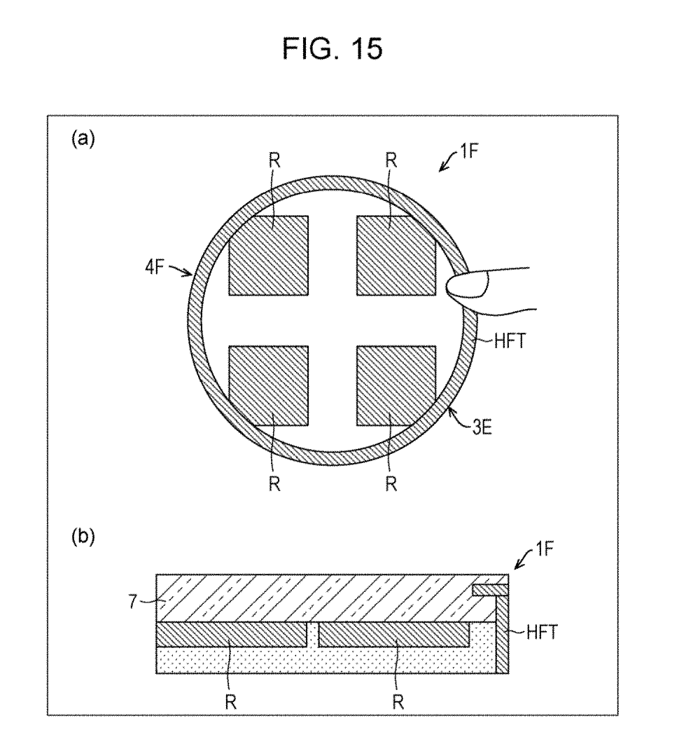

FIG. 15(a) is a schematic plan diagram of another touch panel-equipped display device 1F according to the fifth embodiment. FIG. 15(b) is a schematic cross-section diagram thereof.

A capacitive touch panel 4F of the touch panel-equipped display device 1F includes a housing transmitting electrode HFT formed on the disc-shaped housing 3E and a plurality of square-shaped receiving electrodes R disposed in a matrix shape on the display panel.

As described above, even with a simple configuration in which all electrodes on the display panel are the receiving electrodes R, forming the housing transmitting electrode HFT on the housing 3E enables high-sensitivity detection of a touch position on the housing 3E.

When the housing 3E is configured to have a disc shape as illustrated in FIGS. 13 and 15, for example, in a case where the touch panel-equipped display device 1E or 1F is mounted on an automobile as a sound volume indicator of an acoustic device, a touch on a side face of the housing 3E can be detected, enabling sound volume adjustment by moving (hereinafter, also referred to as “tracing”) a finger with the finger in contact with the side face of the housing 3E. Operability is thought to become better when tracing a side face of the housing 3E than when tracing the surface of the touch panel. Furthermore, a side face of the housing 3E is easier to be traced than the surface of the touch panel, and thus, operability and safety when the operation is performed while driving are thought to be improved.

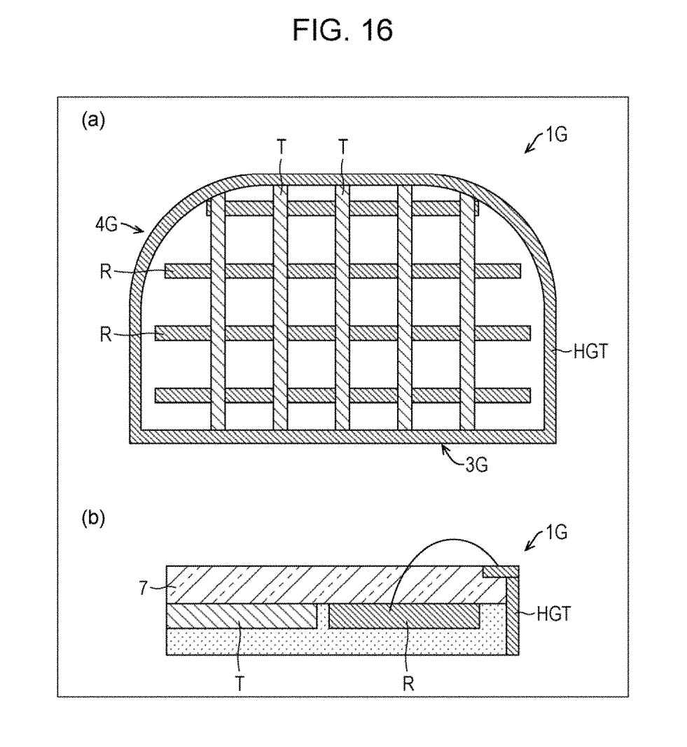

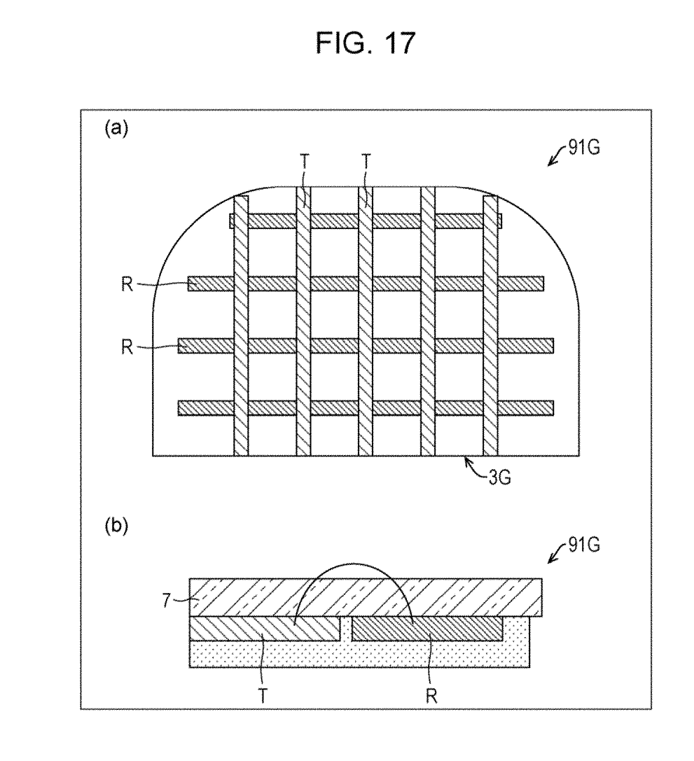

FIG. 16(a) is a schematic plan diagram of still another touch panel-equipped display device 1G according to the fifth embodiment. FIG. 16(b) is a schematic cross-section diagram thereof. FIG. 17(a) is a schematic plan diagram of a conventional touch panel-equipped display device 91G. FIG. 17(b) is a schematic cross-section diagram thereof.

The conventional irregular-shaped touch panel-equipped display device 91G has no electrode on the housing 3G as illustrated in FIGS. 17(a) and 17(b). When the housing 3G is touched, the detection signal is low, making it difficult to detect the touch.

The housing 3G on the touch panel-equipped display device 1G has an irregular shape in which a horizontally long rectangle is formed with the upper left corner and the upper right corner processed to be curved when viewed from the front, as illustrated in FIG. 16(a), and accommodates a display panel (not illustrated) that is formed in the above-described irregular shape. On the irregular-shaped display panel, an irregular-shaped capacitive touch panel 4G is disposed. The capacitive touch panel 4G is provided with a housing transmitting electrode HGT that is formed on the outer edge and the circumferential face of the surface of the housing 3G.

### Sixth Embodiment

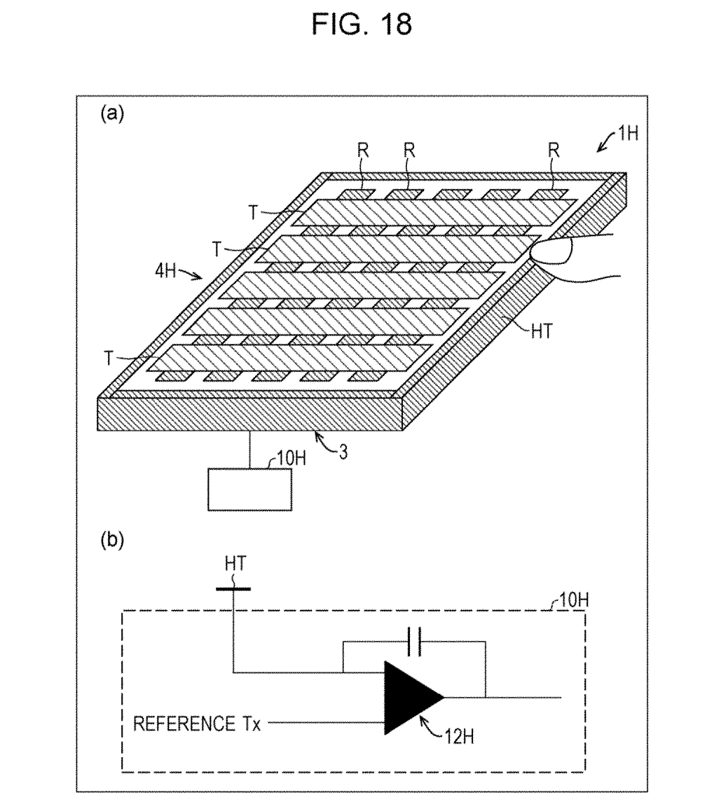

FIG. 18(a) is a perspective diagram of a touch panel-equipped display device 1H according to a sixth embodiment. FIG. 18(b) is a circuit diagram of a proximity sensor provided on the touch panel-equipped display device 1H. A component having the same function as that described in the above-described embodiments will be denoted with the same reference character, and the description thereof will be omitted.

The touch panel-equipped display device 1H includes a capacitive touch panel 4H and a touch panel controller 10H that controls the capacitive touch panel 4H. The capacitive touch panel 4H includes a housing transmitting electrode HT that is formed continuously along four side walls of the housing 3 and driven by the drive voltage.

A conventional capacitive touch panel has limitations with respect to the shape, the width (5 mm), and the area of the transmitting electrode and the receiving electrode, and thus, it has been difficult to implement a proximity sensor function.

The housing transmitting electrode HT according to the sixth embodiment has a loop shape and may be configured to have a wider area than those of the transmitting electrodes T and the receiving electrodes R that are disposed on the surface of the display panel. With this, by providing an amplifier 12H that receives a signal from the receiving electrode R corresponding to the housing transmitting electrode HT and a reference voltage corresponding to the housing transmitting electrode HT in the touch panel controller 10H as illustrated in FIG. 18(b), the touch panel-equipped display device 1H can implement a proximity sensor function.

That is to say, the touch panel controller 10H can detect objects coming close to the housing transmitting electrode HT and discriminate the characteristics of the objects coming close to the housing transmitting electrode HT. For example, the touch panel controller 10H can discriminate whether the object coming close to the housing transmitting electrode HT is a hand or a cover of the mobile terminal mounted with the touch panel-equipped display device 1H. Accordingly, the touch panel controller 10H may be configured to automatically turn off the power of the touch panel-equipped display device 1H when the cover of the mobile terminal comes close to the housing 3. Furthermore, a user interface (UI) that gives a feedback reaction when a hand comes close to the housing 3 may be displayed on the liquid crystal panel 2. Operability of the touch panel-equipped display device 1H is thus improved.

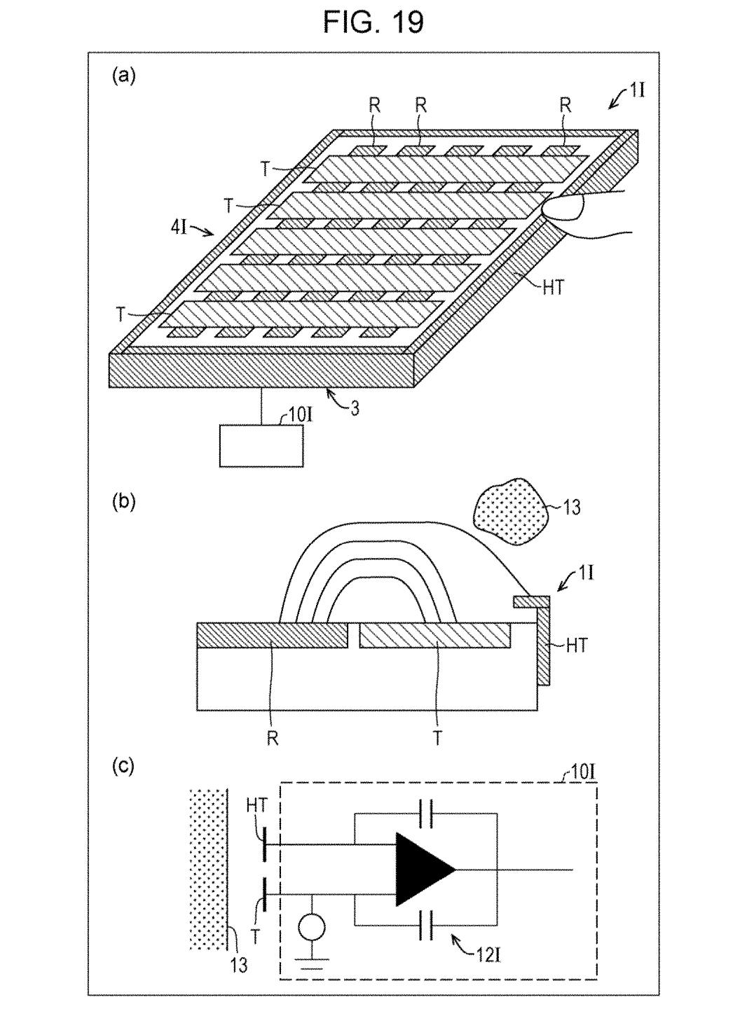

FIG. 19(a) is a perspective diagram of another touch panel-equipped display device 1I according to the sixth embodiment. FIG. 19(b) is a schematic cross-section diagram of the touch panel-equipped display device 1I. FIG. 19(c) is a circuit diagram of an environment sensor provided on the touch panel-equipped display device 1I.

The touch panel-equipped display device 1I includes a capacitive touch panel 4I and a touch panel controller 10I that controls the capacitive touch panel 4I. The capacitive touch panel 4I includes a housing transmitting electrode HT that is formed continuously along four side walls of the housing 3 and driven by the drive voltage.

With a conventional capacitive touch panel, it has been difficult to discriminate whether a touching object is a conductive material or a non-conductive material.

As illustrated in FIG. 19(c), the touch panel controller 10I is provided with an amplifier 12I that receives a signal from the receiving electrode R corresponding to the housing transmitting electrode HT and a signal corresponding to the transmitting electrode T for discriminating whether a touching object 13 is a conductive material or a non-conductive material.

As illustrated in FIG. 19(b), when the transmitting electrodes T and the receiving electrodes R are provided on the surface of the display panel and the housing transmitting electrode HT is disposed in a position more distant from the receiving electrodes R than from the transmitting electrodes T, in a case where the touching object is a conductive material, as the conductive material comes closer, the coupling capacitance between the transmitting electrode T and the receiving electrode R and the coupling capacitance between the housing transmitting electrode HT and the receiving electrode R are both decreased. By contrast, when the touching object is a non-conductive material, as the non-conductive material comes closer, the coupling capacitance between the transmitting electrode T and the receiving electrode R is increased, but the coupling capacitance between the housing transmitting electrode HT, which is in a position more distant from the receiving electrode R than from the transmitting electrode T, and the receiving electrode R is decreased.

Based on the increase and decrease tendency as described above, the touch panel controller 10I discriminates whether the touching object 13 is a conductive material or a non-conductive material. This enables to discriminate whether the touching object 13 is a finger (conductive material) or a glove (non-conductive material), for example, and thus, the touch panel controller 10I can switch the operation mode based on the discrimination result. As described above, because the touch panel controller 10I acknowledges the environment whether the touching object 13 is a conductive material or a non-conductive material when switching the operation mode, erroneous operations are reduced, enabling reduction of power consumption.

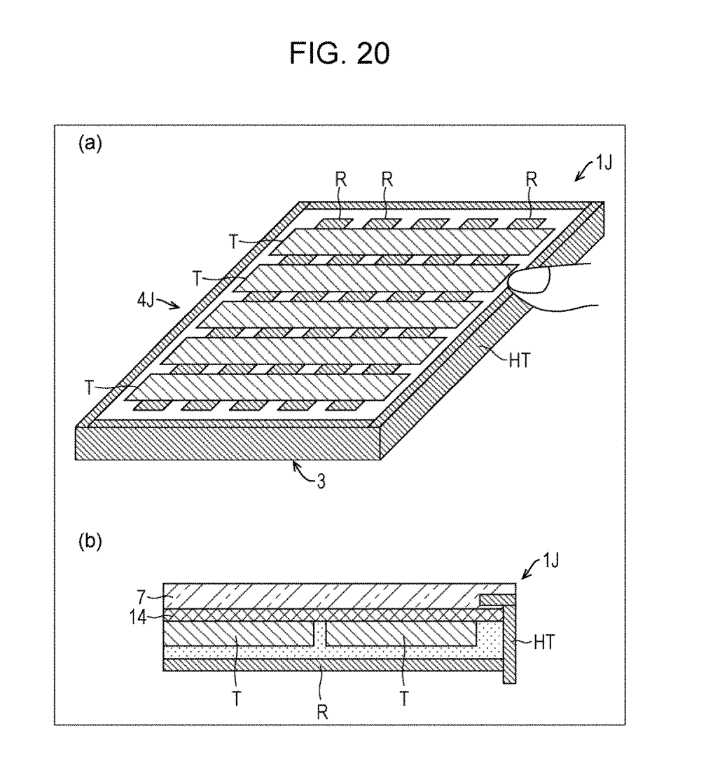

FIG. 20(a) is a perspective diagram of still another touch panel-equipped display device 1J according to the sixth embodiment. FIG. 20(b) is a schematic cross-section diagram of the touch panel-equipped display device 1J.

The touch panel-equipped display device 1J includes a capacitive touch panel 4J. The capacitive touch panel 4J includes a plurality of band-shaped transmitting electrodes T disposed in parallel with each other and driven by a drive voltage and a plurality of band-shaped receiving electrodes R disposed in parallel with each other so as to cross the plurality of transmitting electrodes T and arranged to read a signal based on a capacitance in between the receiving electrodes R and the transmitting electrodes T driven by the drive voltage, on the display panel. The capacitive touch panel 4J further includes a housing transmitting electrode HT that is formed continuously along four side walls of the housing 3 and driven by the drive voltage and a pressure reactive material 14 that is disposed between the transmitting electrodes T and the housing transmitting electrodes HT and reacts to a pressure.

Because the transmitting electrodes T and the receiving electrodes R are formed on the same substrate on the display panel, the thickness of the electrodes and distances and capacitances between electrodes are fixed.

With a conventional capacitive touch panel, it has been difficult to implement pressure sensing. In the touch panel-equipped display device 1J according to the sixth embodiment, the pressure reactive material 14 that reacts to a pressure is disposed between the housing transmitting electrodes HT and the transmitting electrodes T. With this, the capacitance between the housing transmitting electrode HT and the receiving electrode R changes depending on the pressure reactive material 14 that reacts to a pressure. Accordingly, a signal based on a capacitance between the housing transmitting electrode HT and the receiving electrode R, which changes depending on the pressure reactive material 14, is read through the receiving electrode R to be analyzed, whereby a pressure applied on the capacitive touch panel 4J can be detected.

This configuration enables to discriminate between a feather touch input and a touch input by an intense pressing pressure. With this, a character input can be performed by an intense pressing pressure without erroneous operations, facilitating easiness of a character input.

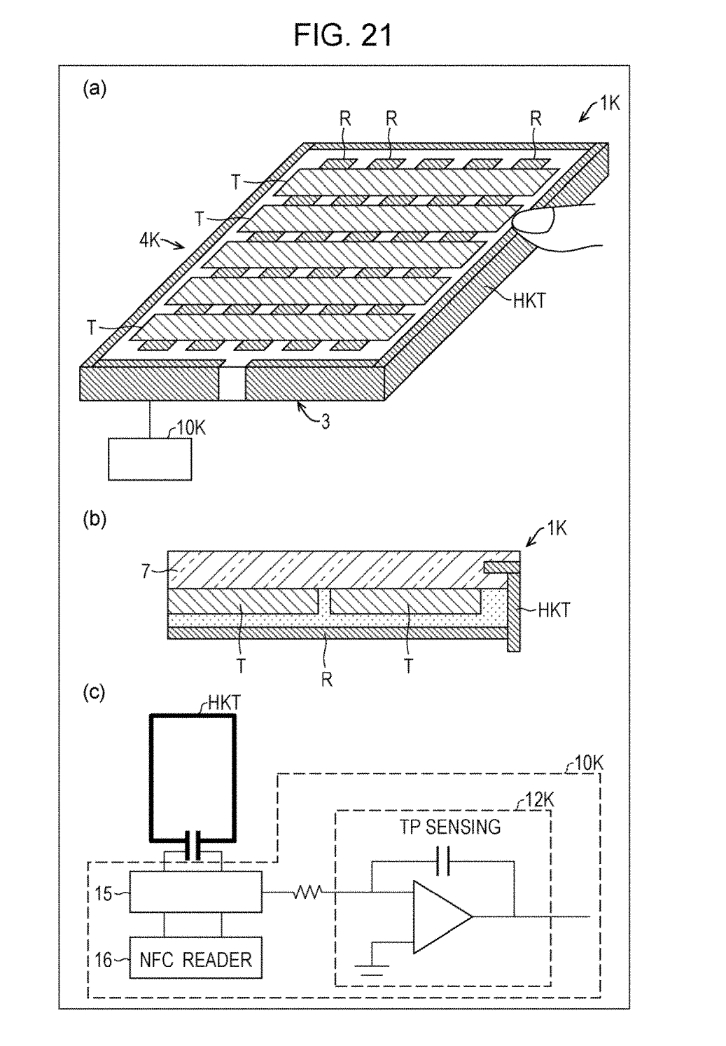

FIG. 21(a) is a perspective diagram of yet another touch panel-equipped display device 1K according to the sixth embodiment. FIG. 21(b) is a schematic cross-section diagram of the touch panel-equipped display device 1K. FIG. 21(c) is a block diagram illustrating a relation among a loop antenna, a near-field communication (NFC) reader 16, and an amplifier 12K (sensing circuit) that are provided on the touch panel-equipped display device 1K.

The touch panel-equipped display device 1K includes a capacitive touch panel 4K and a touch panel controller 10K that controls the capacitive touch panel 4K. The capacitive touch panel 4K has a housing transmitting electrode HKT that is formed in a loop shape along four side walls of the housing 3 and driven by the drive voltage.

As illustrated in FIG. 21(c), the touch panel controller 10K is provided with the NFC reader 16, the amplifier 12K that amplifies a signal read from the receiving electrode R, and a switch 15 that connects the housing transmitting electrode HKT to the NFC reader 16 or the amplifier 12K.

In a conventional touch panel-equipped display device, an NFC antenna is provided separately from a capacitive touch panel. In the touch panel-equipped display device 1K according to the present embodiment, when the switch 15 is switched and the housing transmitting electrode HKT is connected to the NFC reader 16, the housing transmitting electrode HKT functions as an NFC antenna. With this, no separate NFC antenna has to be provided.

In the above-described first to sixth embodiments, examples in which the housing is provided with the transmitting electrode (housing transmitting electrode) have been presented. However, the present invention is not limited thereto. The housing may be configured to be provided with the receiving electrode (housing receiving electrode) and may be configured to be provided with both of the transmitting electrode (housing transmitting electrode) and the receiving electrode (housing receiving electrode). It is sufficient if the housing is provided with at least one of the transmitting electrode (housing transmitting electrode) and the receiving electrode (housing receiving electrode).

### SUMMARY

A touch panel-equipped display device 1 or 1A to 1K according to a first aspect of the present invention includes a display panel (liquid crystal panel 2), a housing 3, 3E, or 3G that accommodates the display panel (liquid crystal panel 2), and a capacitive touch panel 4 or 4A to 4K for operating the display panel (liquid crystal panel 2). The capacitive touch panel 4 or 4A to 4K has a transmitting electrode (housing transmitting electrode HT) driven by a drive voltage and a receiving electrode to read a signal based on a capacitance in between the receiving electrode and the transmitting electrode T (housing transmitting electrode HT) driven by the drive voltage. At least one of the transmitting electrode (housing transmitting electrode HT) and the receiving electrode is disposed on the housing 3, 3E, or 3G.

With the above-described configuration, because at least one of the transmitting electrode and the receiving electrode is disposed on the housing, even when an edge of the housing is touched, excellent detection of a signal is possible. With this, a touch panel-equipped display device that enables excellent detection of a touch on a housing that accommodates a display panel can be implemented.

A touch panel-equipped display device 1 or 1A to 1K according to a second aspect of the present invention may have a configuration in which, in the above-described first aspect, the transmitting electrode (housing transmitting electrode HT) is disposed on a side face of the housing 3, 3E, or 3G and the receiving electrode R is disposed on the surface of the display panel (liquid crystal panel 2).

With the above-described configuration, because the transmitting electrode is disposed on a side face of the housing, even when an edge of the housing is touched, excellent detection of a signal is possible.

A touch panel-equipped display device 1, 1A to 1E, or 1G to 1K according to a third aspect of the present invention may have a configuration in which, in the above-described second aspect, another transmitting electrode T is disposed on the surface of the display panel (liquid crystal panel 2).

With the above-described configuration, adding a housing transmitting electrode in a conventional configuration formed of a transmitting electrode and a receiving electrode enables excellent detection of a touch signal on an edge of the housing.

A touch panel-equipped display device 1 or 1A to 1K according to a fourth aspect of the present invention may have a configuration in which, in the above-described second aspect, a wire 19 disposed on the surface of the display panel (liquid crystal panel 2) is connected to the transmitting electrode (housing transmitting electrode HT) disposed on the housing 3, 3E, or 3G.

With the above-described configuration, the transmitting electrode disposed on the housing can be connected to a touch panel controller with a simple configuration.

A touch panel-equipped display device 1 or 1A to 1K according to a fifth aspect of the present invention may have a configuration in which, in the above-described fourth aspect, a wire 19 disposed on the surface of the display panel (liquid crystal panel 2) is connected to the transmitting electrode (housing transmitting electrode HT) disposed on the housing 3, 3E, or 3G using at least one of a conductive seal (conductive seal member 9), a flexible connector 11, and a cover glass 7.

With the above-described configuration, a wire disposed on the surface of the display panel can be connected to the transmitting electrode disposed on the housing with a simple configuration.

A touch panel-equipped display device according to a sixth aspect of the present invention may have a configuration in which, in the above-described first aspect, the receiving electrode is disposed on a side face of the housing 3, 3E, or 3G and the transmitting electrode T is disposed on the surface of the display panel (liquid crystal panel 2).

With the above-described configuration, based on a change in a capacitance between the transmitting electrode disposed on the surface of the display panel and the receiving electrode disposed on a side face of the housing, excellent detection of a touch signal on an edge of the housing is possible.

A touch panel-equipped display device according to a seventh aspect of the present invention may have a configuration in which, in the above-described sixth aspect, another receiving electrode (receiving electrode R) is disposed on the surface of the display panel (liquid crystal panel 2).

With the above-described configuration, adding a housing receiving electrode in a conventional configuration formed of a transmitting electrode and a receiving electrode enables excellent detection of a touch signal on an edge of the housing.

A touch panel-equipped display device according to an eighth aspect of the present invention may have a configuration in which, in the above-described sixth aspect, a wire disposed on the surface of the display panel (liquid crystal panel 2) is connected to the receiving electrode disposed on the housing 3, 3E, or 3G.

With the above-described configuration, the receiving electrode disposed on the housing can be connected to the touch panel controller with a simple configuration.

A touch panel-equipped display device according to a ninth aspect of the present invention may have a configuration in which, in the above-described first aspect, both of the transmitting electrode and the receiving electrode are disposed on a side face of the housing 3, 3E, or 3G.

With the above-described configuration, based on a change in a capacitance between the transmitting electrode disposed on a side face of the housing and the receiving electrode disposed on the side face of the housing, excellent detection of a touch signal on an edge of the housing is possible.

A touch panel-equipped display device according to a tenth aspect of the present invention may have a configuration in which, in the above-described ninth aspect, another transmitting electrode (transmitting electrode T) and another receiving electrode (receiving electrode R) are disposed on the surface of the display panel (liquid crystal panel 2).

With the above-described configuration, adding a housing transmitting electrode and a housing receiving electrode in a conventional configuration formed of a transmitting electrode and a receiving electrode enables excellent detection of a touch signal on an edge of the housing.

A touch panel-equipped display device 1 or 1D to 1K according to an eleventh aspect of the present invention may have a configuration in which, in any one of the above-described first to tenth aspects, the transmitting electrode or the receiving electrode is formed over the entire circumference of a side face of the housing 3, 3E, or 3G.

With the above-described configuration, excellent detection of a touch signal is enabled over the entire circumference of a side face of the housing.

A touch panel-equipped display device 1C according to a twelfth aspect of the present invention may have a configuration in which, in any one of the above-described first to tenth aspects, at least one of the transmitting electrode and the receiving electrode is formed dividedly along the circumferential direction of a side face of the housing 3, 3E, or 3G.

With the above-described configuration, the resolution of signal detection based on a touch on a side face of the housing can be improved.

A touch panel-equipped display device 1, 1A to 1C, or 1H to 1K according to a thirteenth aspect of the present invention may have a configuration in which, in any one of the above-described first to twelfth aspects, the housing 3 is formed in a rectangular plate shape.

With the above-described configuration, the touch panel-equipped display device can be suitably applied to a mobile terminal.

A touch panel-equipped display device 1E according to a fourteenth aspect of the present invention may have a configuration in which, in any one of the above-described first to twelfth aspects, the housing 3E is formed in a disc shape.

With the above-described configuration, the touch panel-equipped display device can be suitably applied to an on-vehicle display device.

The present invention is not limited to any of the above-described embodiments. Various changes within the range indicated in the claims are possible. An embodiment obtained by combining as appropriate technical means disclosed in different embodiments also is included in the technical scope of the present invention. Furthermore, by combining technical means disclosed in the embodiments, a new technical feature can be formed.

### REFERENCE SIGNS LIST

1 touch panel-equipped display device
2 liquid crystal panel (display panel)
3 housing
4 capacitive touch panel
19 wire
T transmitting electrode (transmitting electrode, another transmitting electrode)
R receiving electrode (receiving electrode, another receiving electrode)
HT housing transmitting electrode (transmitting electrode)

1. A touch panel-equipped display device comprising:
a display panel;
a housing that accommodates the display panel; and
a capacitive touch panel for operating the display panel, wherein
the capacitive touch panel includes
a transmitting electrode driven by a drive voltage, and
a receiving electrode arranged to read a signal based on a capacitance in between the receiving electrode and the transmitting electrode driven by the drive voltage, and
at least one of the transmitting electrode and the receiving electrode is disposed on the housing.

2. The touch panel-equipped display device according to claim 1, wherein
the transmitting electrode is disposed on a side face of the housing, and
the receiving electrode is disposed on the surface of the display panel.

3. The touch panel-equipped display device according to claim 2, wherein
another transmitting electrode is disposed on the surface of the display panel.

4. The touch panel-equipped display device according to claim 2, wherein
a wire disposed on the surface of the display panel is connected to the transmitting electrode disposed on the housing.

5. The touch panel-equipped display device according to claim 4, wherein
a wire disposed on the surface of the display panel is connected to the transmitting electrode disposed on the housing using at least one of a conductive seal, a flexible connector, and a cover glass.

6. The touch panel-equipped display device according to claim 1, wherein
the receiving electrode is disposed on a side face of the housing, and
the transmitting electrode is disposed on the surface of the display panel.

7. The touch panel-equipped display device according to claim 6, wherein
another receiving electrode is disposed on the surface of the display panel.

8. The touch panel-equipped display device according to claim 6, wherein
a wire disposed on the surface of the display panel is connected to the receiving electrode disposed on the housing.

9. The touch panel-equipped display device according to claim 1, wherein
both of the transmitting electrode and the receiving electrode are disposed on a side face of the housing.

10. The touch panel-equipped display device according to claim 9, wherein
another transmitting electrode and another receiving electrode are disposed on the surface of the display panel.

11. The touch panel-equipped display device according to claim 1, wherein
the transmitting electrode or the receiving electrode is formed over the entire circumference of a side face of the housing.

12. The touch panel-equipped display device according to claim 1, wherein
at least one of the transmitting electrode and the receiving electrode is formed dividedly along the circumferential direction of a side face of the housing.

13. The touch panel-equipped display device according to claim 1, wherein
the housing is formed in a rectangular plate shape.

14. The touch panel-equipped display device according to claim 1, wherein
the housing is formed in a disc shape.
